(19) United States
(12) Patent Application Publication
(10) Pub. No.: US 2010/0092738 A1
(43) Pub. Date: Apr. 15, 2010

(54) SYSTEM AND METHOD FOR FORMING IMAGES ON A PLASTIC IMPLEMENT

(76) Inventors: Scott Moncrieff, La Jolla, CA (US); Michael D. Ward, San Diego, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/541,100

(22) Filed: Aug. 13, 2009

Related U.S. Application Data
(60) Provisional application No. 61/088,615, filed on Aug. 13, 2008.

(51) Int. Cl. B32B 3/10; B32B 38/14; B32B 37/24; B29C 45/14

(52) U.S. Cl. 428/195.1; 156/277; 156/242

(57) ABSTRACT

A system and method for taking orders for, and on-demand manufacturing of, personalized plastic event/party plates that may either be saved and reused or disposed of and recycled. In any given order, any number of plates may have a single unique high resolution photograph, or every plate may have a unique and different photograph. The images are preprinted on plastic film and are molded into the plate to become a permanent feature of the plate.

### CROSS REFERENCE TO RELATED ED APPLICATIONS

This application claims the benefit of priority under 35 U.S.C. §119 to U.S. Provisional Patent Application Ser. No. 61/088,615, filed on Aug. 13, 2008, entitled, “SYSTEM AND METHOD FOR FORMING IMAGES ON A PLASTIC IMPLEMENT”, the entire disclosures of which is incorporated by reference herein.

### BACKGROUND

Attaching an image or picture to an item is one way of personalizing the item and making it special to the user or owner of the item. Conventional techniques for providing an image or picture to an item, such as a plate, for example, include forming the plate, and then printing the image onto the plate by depositing ink or paint directly to the surface of the item. Another technique includes screening of the image onto the surface of the plate, which is similar yet slightly different printing technique.

In such conventional image application techniques, the images can easily be scraped or scratched off of the surface of the item. Yet, while such techniques are fairly quick, and many items can be printed with an image during a run, other ways of providing an image to an item can be costly and yield very low numbers of finished products.

### SUMMARY

This document presents a system and method for providing an eating implement with a high-resolution image. In one aspect, a system and method for providing a high-resolution image to an eating implement is disclosed. The system and method include mechanisms for injection molding the implement, digitally printing an image onto a transparent film, and then molding the imaged transparent film to a base of the implement.

In another aspect, a system and method are disclosed for receiving an order, via a website, for one or more imaged products, and fulfilling the order with one or more manufactured imaged products according to the order. The systems and methods disclosed herein enable a large number of implements to be printed with a single image, or each with their own unique image. The disclosed systems and methods further enable an image to be applied to an implement, in which the image is not easily removed, scratched away or otherwise compromised.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 illustrates an eating implement, which in this example is a plate.

FIG. 2 illustrates a printed transparent film about to be molded to the eating implement.

FIG. 3 is a side view of the printed transparent film and the eating implement.

FIG. 4 illustrates the printed transparent film molded to the plate.

FIG. 5 shows a picture plate with appliqué on top.

FIG. 6 is a sectioned view of a molded plate with appliqué applied to the top of the plate.

FIG. 7 shows a picture plate with appliqué on the bottom.

FIG. 8 is a sectioned view of a molded plate with appliqué applied to the bottom of the plate.

Like reference symbols in the various drawings indicate like elements.

### DETAILED DESCRIPTION

This document describes a heavy gauge disposable plastic eating implement, such as a plate, cup, bowl, utensil, etc., that includes an integrally-molded picture or image in a base of the implement.

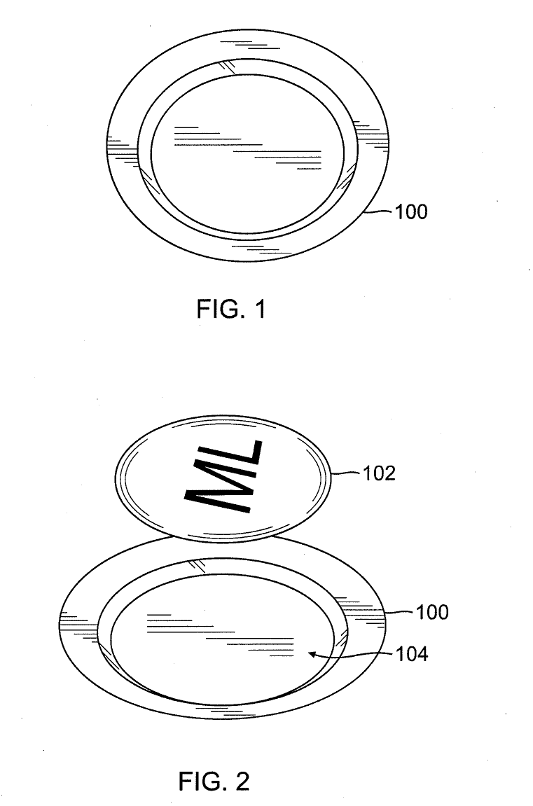

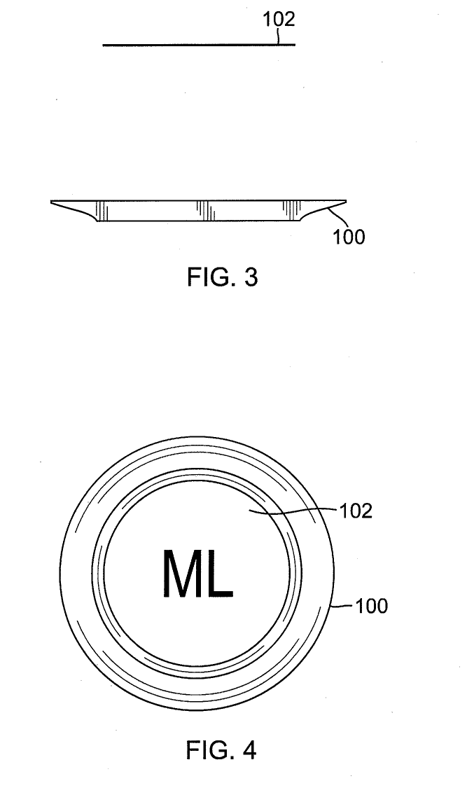

In exemplary embodiments, an implement 100 is injection molded out of a transparent, FDA-approved clear resin, as shown in FIG. 1. As shown in FIGS. 2-4, an image or photograph is digitally printed on a second surface 102 of transparent film, which is then molded into a base 104 of the implement 100. Although the implements are preferably disposable, they are preferably of sufficient weight and quality that they may be kept and reused or displayed as mementos of a special occasion for which they were created. Typical uses for the implement include serving food, candy, cake, or buffet items at special parties or events such as a wedding, anniversaries, birthdays, wedding showers, bar mitzvahs, baby showers and various types of corporate meetings or marketing events.

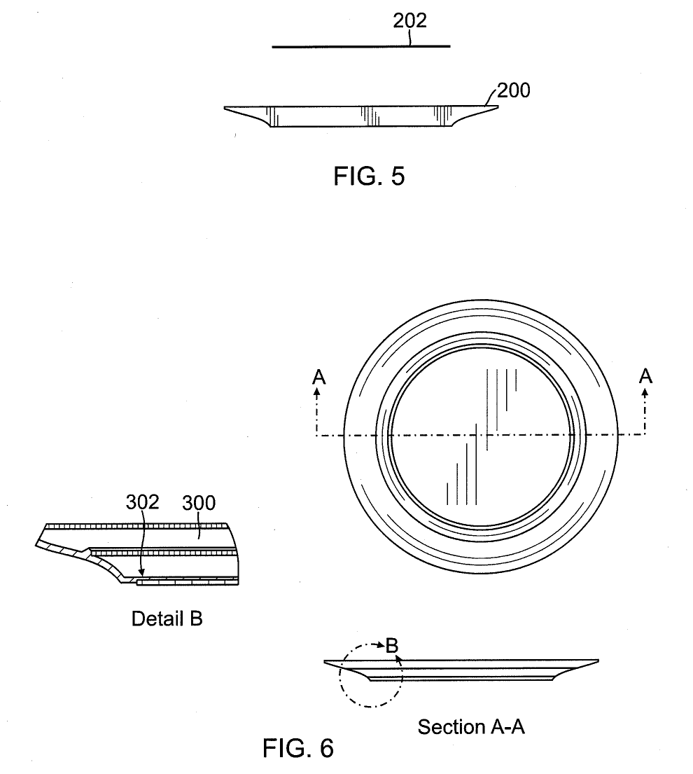

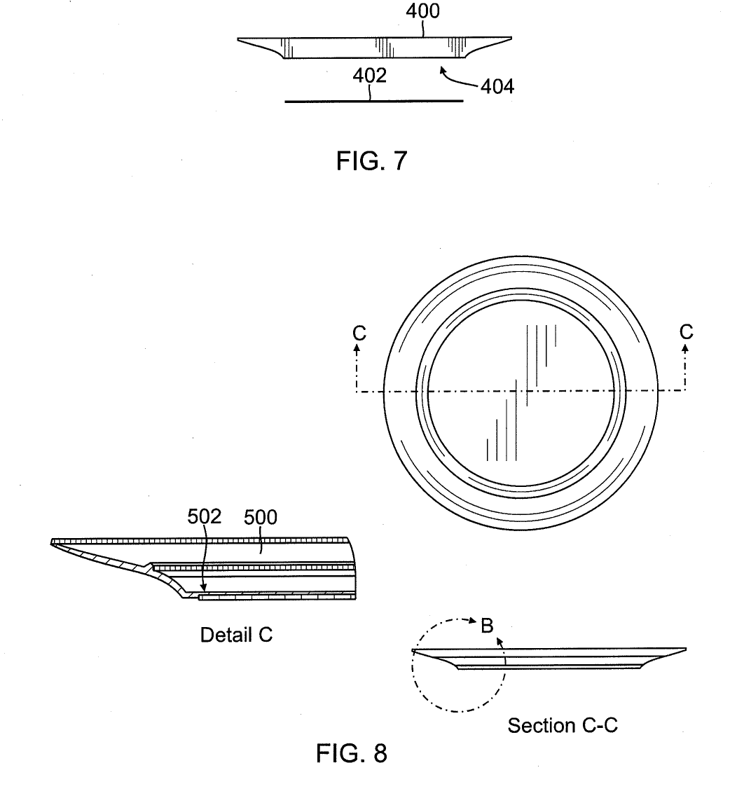

The printed transparent film, or appliqué, can be molded to the top or bottom of the implement 100. The implement can be a plate. FIG. 5 shows a picture plate 200 with appliqué 202 on top, and FIG. 6 is a sectioned view of a molded plate 300 with appliqué 302 applied to the top of the plate. FIG. 7 shows a picture plate 400 with an appliqué 402 to be applied on a bottom 404 of the picture plate 400, and FIG. 8 is a sectioned view of a molded plate 500 with appliqué 502 applied to the bottom of the plate.

Alternatively, the appliqué could be laminated prior to molding to give added protection and better durability. The appliqué can be printed using other print methods such as silkscreen, flexography, offset, rotogravure, or other digital printing methods. The ink is preferably an ink that will not run, smear or scratch easily.

In yet other alternatives, the plate can be made simply by printing on a label stock and applying the label to either the top or bottom of the plate. This would be an alternative to the molding type of process, but still use the web ordering and digital printing as described below. These implementations can use one or more automated application processes to apply the labels to the pre-molded plates.

Incorporating one or more images or pictures into the eating implements used at these types of special events is a way to add a unique and personal touch to the event, helping make it a success. The systems and techniques described herein provide a unique way to showcase and highlight images from people's lives that are meaningful in a way all the guests can relate to, as well as provide a way to communicate a special message to all the people in attendance.

Placing an Order

In an exemplary embodiment, a system and method receives an order from a customer, via a website hosted by a server, for a specified number of plates using one or more images provided by the user. The user can upload the images in digital format from a client computer to a layout template on the website via a communications network, and add a message or text to the image. Once the customer is satisfied with the image design, the item is added to an online shopping cart hosted by or linked to the website. The customer can make another design or check out. Customers will receive their ordered products, i.e. implements with an image, in a number of days via mail. The user may upload any number of images, and can specify the number of implements they would like of each image.

Order Fulfillment

The orders are downloaded over the communications network, such as the Internet, and placed into an SQL database for processing. The data is processed and the images are transferred to layout application software which creates the print pages based on the individual order that was placed. These files are then transferred to a digital printer queue for printing.

Some or all of the ordering and order fulfillment functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Manufacturing

In preferred implementations, the files are printed using a printing press, such as an HP Indigo 4000 series printing press. From there they are placed on a finishing machine that corona treats the printed image and applies a special protective coating to the print side of the film. The printed film is masked with a clear protective film and then die cut into individual pieces. The orders are then staged for molding. Once they have been molded into the respective implements, their tracking tag is scanned and they are packaged and shipped. Detailed order information and a barcode are printed onto a special film tag that is printed as part of the order and travels with the order and is used for order tracking and data collection purposes.

In alternative implementations, the ordered images are printed to labels, such as transparent labels, which are then manually or automatically affixed to the top or bottom of an ordered object, such as a plate, cup, utensil, etc. The object is preferably formed of durable plastic for longer keeping than immediate disposal.

Although a few embodiments have been described in detail above, other modifications are possible. The logic flows described herein do not require the particular order shown, or sequential order, to achieve desirable results. Other embodiments may be within the scope of the following claims.

1. A method of producing a plate with an image, the method comprising:
forming a plate;
printing a digital image onto a transparent film to form an appliqué; and
molding the appliqué to a base of the plate to produce the plate with the image.

2. The method in accordance with claim 1, wherein forming the plate includes forming the plate with an injection molding process.

3. The method in accordance with claim 1, wherein the plate is formed of a clear resin material.

4. The method in accordance with claim 1, wherein the digital image is printed using a digital printing technique from a group of printing techniques that consists of: silkscreen, flexography, offset, and rotogravure.

5. The method in accordance with claim 1, further comprising coating the base of the plate with a protective coating to protect the appliqué.

6. The method in accordance with claim 1, wherein the base of the plate is located on the top of the plate.

7. The method in accordance with claim 1, wherein the base of the plate is located on the bottom of the plate.

8. A method of producing a plastic implement with an image, the method comprising:
providing the plastic implement;
printing a digital image onto a transparent film to form an appliqué; and
molding the appliqué to a base of the plastic implement to produce the plastic implement with the image.

9. The method in accordance with claim 8, wherein the plastic implement is a plate formed by injection molding.

10. An image-bearing plastic implement comprising:
a plastic implement formed by an injection molding process;
an appliqué having an image, the appliqué being fixedly applied to a base of the plastic image by an application process;
wherein the fixed application of the appliqué to the base of the plastic implement forms the image-bearing plastic implement.
